(19) United States
(12) Patent Application Publication
(10) Pub. No.: US 2005/0025884 A1
(43) Pub. Date: Feb. 3, 2005

(54) Method for manufacturing chemical filter

(75) Inventors: Teruzi Yamazaki, Yokohama-shi (JP); Toshiro Nakano, Yokohama-shi (JP); Akihiro Imai, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NICHIAS CORPORATION, Tokyo (JP)

(21) Appl. No.: 10/893,954

(22) Filed: Jul. 20, 2004

(30) Foreign Application Priority Data
Jul. 31, 2003 (JP) 2003-283630

(51) Int. Cl. B05D 1/12

(52) U.S. Cl. 427/180

(57) ABSTRACT

A method for manufacturing a chemical filter with a corrugated honeycomb structure is disclosed. The method comprises coating a fiber paper with a slurry mixture of an ion-exchange resin powder and an adhesive to obtain an ion-exchange resin-coated paper with the ion-exchange resin powder attached to the surface and inside of the fiber paper, and forming a chemical filter with a corrugated honeycomb structure using the ion-exchange resin-coated paper. The average particle diameter of the ion-exchange resin powder is preferably 1-150 μm. In addition, the ion-exchange resin powder preferably has an ion-exchange capacity of 1-10 meq/g.

### TECHNICAL FIELD

The present invention relates to a method for manufacturing a chemical filter for air cleaning used in clean rooms and apparatuses in facilities for manufacturing semiconductors, liquid crystals, and precision electronic parts in which ionized gaseous pollutants are produced.

### BACKGROUND ART

In frontier industries such as the semiconductor manufacturing industry and liquid crystal manufacturing industry, controlling pollution of the air and product surfaces in clean rooms to prevent pollution is important to ensure a high yield, high quality, and reliability of the products. In the semiconductor manufacturing industry, in particular, as the degree of integration of the products increases, control of ionized gaseous pollutants has become indispensable in addition to the control of particulate matters using a HEPA filter, ULPA filter, and the like.

In the present invention, ionized gaseous pollutants indicate basic gases and acidic gases. Of these gases, the basic gases such as ammonia are known to adversely affect resolution during the step of exposure to radiation and cause wafer surfaces to become clouded in the manufacture of semiconductor devices. SO_{X}, which is an acidic gas, produces lamination defects in substrates in the thermal oxidation membrane-forming process during manufacture of semiconductors, whereby the characteristics and reliability of the semiconductor devices are adversely affected.

Since ionized gaseous pollutants cause various problems in semiconductor manufacturing processes and the like in this manner, it is desired to reduce the concentration of the ionized gaseous pollutants in a clean room used in semiconductor manufacturing and the like to several tens of ppb or less.

Japanese Patent Application Laid-open No. 2001-259339 (Patent Document 1) discloses an air filter material in the form of paper comprising a matrix and powder of ion exchange resin having a particle size and ion exchange capacity in specific ranges incorporated into the matrix. The air filter material is formed of paper milled by sufficiently dispersing the ion exchange resin powder in the matrix. Fine particles of ion exchange resin are held on the surface of the pulp matrix by means of an electrostatic force and frictional force so that the fine particles are detached from the matrix only with difficulty. The amount of gas adsorbed is increased by using this air filter material.

Japanese Patent Application Laid-open No. 2000-5544 (Patent Document 2) discloses a deodorant comprising an adsorption medium such as activated carbon, zeolite, or silica gel and an ion-exchange resin. The ion-exchange resin and bad-smelling components once adsorbed in the deodorant can be released only with difficulty from the adsorption medium even in an environment exposed to water.

Japanese Patent Application Laid-open No. 2003-10613 (Patent Document 3) discloses an air filter material comprising a filtering matrix containing powder of an ion-exchange resin and phosphoric acid attached to the matrix by immersion or the like. Due to a large amount of phosphoric acid carried on the filter material, the amount of alkaline ionized gases adsorbed markedly increases.
(Patent Document 1) Japanese Patent Application Laid-open No. 2001-259339 (pages 2 and 4)
(Patent Document 2) Japanese Patent Application Laid-open No. 2000-5544 (pages 2 and 5)
(Patent Document 3) Japanese Patent Application Laid-open No. 2003-10613 (pages 2 and 6)

However, in the air filter material described in Document 1, if a large amount of fine particles of ion exchange resin is attached to the pulp matrix to sufficiently remove ionized gaseous pollutants, the fine particles of ion exchange resin are easily detached from the matrix because the fine particles are held on the surface of the matrix by means of an electrostatic force or frictional force. If the amount of the fine particles of ion exchange resin is limited to the amount that can be held by the electrostatic force or frictional force, the ionized gaseous pollutants cannot be sufficiently removed.

The deodorant described in Patent Document 2 comprises a mixture of an adsorption medium such as activated carbon and an ion-exchange resin milled into paper. Since it is difficult to increase the amount of ion-exchange resin attached by employing a method of milling paper together with the adsorption medium, ionized gaseous pollutants cannot be sufficiently removed.

The air filter material described in Patent Document 3 is manufactured by milling a mixture of a fibrous material such as pulp and an ion-exchange resin into paper and further adding phosphoric acid. For the same reasons as in the case of the deodorant described in Document 2, it is difficult to increase the amount of ion-exchange resin attached using the method of milling the ion-exchange resin together with fibrous material. Thus, the problem of insufficient removal of ionized gaseous pollutants remains. This filter material removes ionized gaseous pollutants by the neutralization reaction with phosphoric acid. The salt produced by the reaction of the ionized gaseous pollutants with phosphoric acid inhibits dispersion of the gas to be filtered into the inside of the filter. Therefore, the ionized gaseous pollutants cannot sufficiently react with phosphoric acid, resulting in insufficient removal of the ionized gaseous pollutants.

An object of the present invention is, therefore, to provide a method for manufacturing a chemical filter exhibiting improved capability of removing ionized gaseous pollutants due to an increased amount of ion-exchange resin powder attached to a substrate, which can be detached from the filter only with difficulty, and exhibiting only a small pressure loss.

### SUMMARY OF THE INVENTION

As a result of extensive studies to achieve the above object, the inventors of the present invention have found that if a paper coated with an ion-exchange resin is obtained by applying a slurry mixture of an ion-exchange resin powder and an adhesive onto a fiber paper and a chemical filter with a corrugated honeycomb structure is formed from the paper coated with an ion-exchange resin, a large amount of ion-exchange resin powder can be attached to the surface and inside of fiber paper. This finding has led to the completion of the present invention.

Specifically, a present invention (1) provides a method for manufacturing a chemical filter comprising coating a fiber paper with a slurry mixture of an ion-exchange resin powder and an adhesive to obtain an ion-exchange resin-coated paper with the ion-exchange resin powder attached to the surface and inside of the fiber paper, and forming a chemical filter with a corrugated honeycomb structure using the ion-exchange resin-coated paper.

A present invention (2) provide the method described above, wherein the slurry mixture is applied to both sides of the fiber paper and the ion-exchange resin-coated paper has the ion-exchange resin powder attached to the inside and both sides of the fiber paper.

A present invention (3) provides the above method, wherein the ion-exchange resin powder has an average particle diameter of 1-150 μm.

A present invention (4) provides the above method, wherein the ion-exchange resin powder has an ion-exchange capacity of 1-10 meq/g.

A present invention (5) provides the above method, wherein the ion-exchange resin powder comprises anion-exchange resin powder and cation-exchange resin powder.

A present invention (6) provides the above method, wherein the adhesive comprises at least one of inorganic adhesives or organic adhesives.

Since it is possible to firmly attach a large amount of ion-exchange resin powder to the surface as well as to the inside of the fiber paper forming a substrate, the amount of ionized gaseous pollutants reacting per unit volume of the chemical filter prepared using the method of the present invention (1) can be significantly increased, whereby the ionic gaseous pollutant removal life of the chemical filter can be extended. In addition, since the resulting chemical filter has a corrugated honeycomb substrate which allows the flow path for the process air to run parallel to the airflow direction, the pressure drop can be reduced. Therefore, it is possible to employ compact peripheral equipment and reduce costs. In addition, when attaching an ion-exchange resin powder to a fiber paper before forming a chemical filter with a corrugated honeycomb structure, it is possible to adjust the type of the ion-exchange resin powder and the amount to be attached to the one side and the other side of the fiber paper.

According to the method for manufacturing the chemical filter of the present invention (2), the amount the ion-exchange-resin powder attached can be increased.

According to the method for manufacturing the chemical filter of the present invention (3), adhesion of ion-exchange resin powder to the fiber paper can be increased, whereby it is possible to reduce detachment of ion-exchange resin powder from the substrate.

According to the method for manufacturing the chemical filter of the present invention (4), the amount of ionized gaseous pollutants reacted per unit volume of the filter can be increased.

According to the method for manufacturing the chemical filter of the present invention (5), both basic gases (ammonia, amines, etc.) and acidic gases (SO_{X}, NO_{X}, etc.) can be removed.

According to the method for manufacturing the chemical filter of the present invention (6), the ion-exchange resin powder can be firmly attached to both the surface and inside of the fiber paper.

### BRIEF DESCRIPTION OF THE DRAWINGS

FIG. 1 is a schematic drawing describing the process for manufacturing the paper coated with the ion-exchange resin powder of the present invention.

FIG. 2 is a schematic drawing describing the process for manufacturing the paper coated with the ion-exchange resin powder of the present invention.

FIG. 3 is a schematic perspective view of the chemical filter with a corrugated honeycomb structure obtained in the present invention.

FIG. 4 is a schematic sectional view of the chemical filter with a corrugated honeycomb structure obtained in the present invention.

FIG. 5 is a graph showing the change over time of the ammonia gas removal rate.

### DETAILED DESCRIPTION OF THE INVENTION AND PREFERRED EMBODIMENT

Fiber paper used in the present invention means woven fabric or nonwoven fabric formed from fiber. As the fiber paper, inorganic fiber papers made from inorganic fibers such as silica alumina fiber, silica fiber, alumina fiber, mullite fiber, glass fiber, rock wool fiber, and carbon fiber; and organic fiber papers made from organic fibers such as polyethylene fiber, polypropylene fiber, nylon fiber, polyester fiber, polyvinyl alcohol fiber, aramid fiber, pulp fiber, and rayon fiber can be given. Of these fiber papers, inorganic fiber papers, particularly silica alumina fiber paper, are preferable to produce a chemical filter with a high mechanical strength.

The average diameter of the fiber forming the fiber papers is usually in the range of 0.1-25 μm, and preferably 0.5-10 μm, and the average fiber length is usually in the range of 0.1-50 μm, and preferably 10-20 μm. The average diameter and length of the fiber in the above range are desirable to increase the mechanical strength of the fiber paper. The above fiber papers can be used either individually or in combination of two or more.

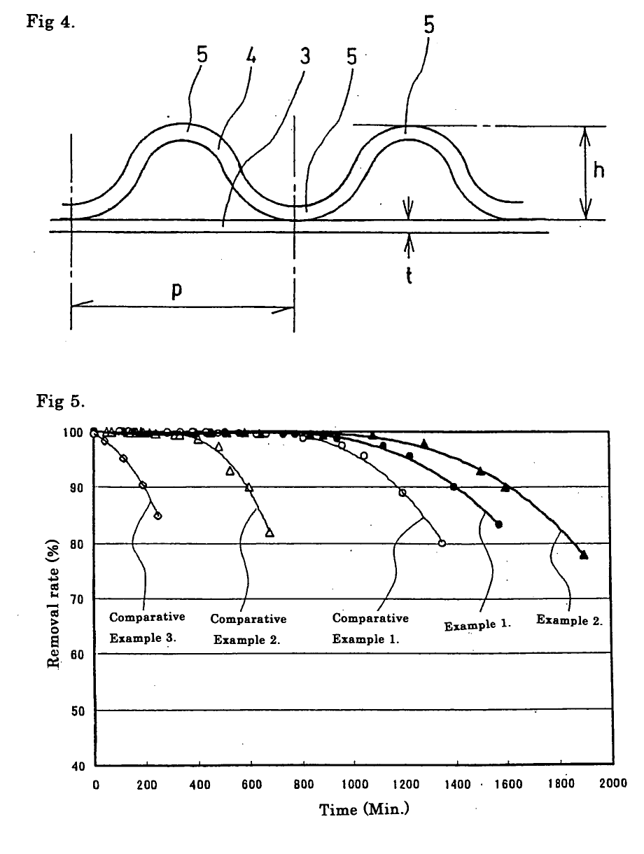

The fiber paper has an inter-fiber void ratio usually of 50-95%, and preferably of 70-95%. The inter-fiber void ratio here indicates a quotient obtained by dividing the total void volume of the fiber paper by the apparent volume of the fiber paper. The void ratio in the above range is preferable, because it is easy to attach a large amount of ion exchange resin powder not only to the surface, but also to the inside of the fiber paper. The inside of fiber paper used herein indicates the space (or void) formed between fibers of woven fabric or nonwoven fabric of fiber paper. The thickness of the fiber paper (t in FIG. 4) is usually 0.1-0.5 mm, and preferably 0.2-0.3 mm. The thickness in the above range is preferable, because it is possible to increase the mechanical strength of the fiber paper and to attach a large amount of ion exchange resin powder to the inside of the fiber paper.

In the present invention, a slurry mixture of ion-exchange resin powder and an adhesive is applied to the fiber paper. As the ion-exchange resin powder used in the present invention, at least one of cation exchange resin powder or anion exchange resin powder can be given, for example. A strongly acidic cation exchange resin, for example, can be given as the cation exchange resin forming the cation exchange resin powder. A strong basic anion exchange resin, for example, can be given as the anion exchange resin forming the anion exchange resin powder.

The ion-exchange resin powder used in the present invention has an average diameter usually of 1-150 μm, and preferably 10-50 μm. If the average diameter is more than 150 μm, the weight of each particle is too large to have sufficient adhesion strength with an adhesive, which may result in detachment of the ion-exchange resin powder. If the average diameter is less than 1 μm, the slurry mixture of the ion-exchange resin powder and the adhesive has too large a viscosity so that it is difficult to obtain fiber paper sufficiently impregnated with the slurry mixture by coating. Only a small amount of the ion-exchange resin powder can attach to the fiber paper.

The ion-exchange resin powder has an ion-exchange capacity usually of 1-10 meq/g, and preferably 3-6 meq/g. If the ion-exchange capacity is less than 1 meq/g, the ion-exchange resin powder exhibits only insufficient reactivity with ionized gaseous pollutants and its performance in removing the ionized gaseous pollutants tends to decrease. If the ion-exchange capacity is more than 10 meq/g, the ion-exchange resin forming the ion-exchange resin powder has only poor chemical stability and the ion-exchange groups tend to be released from the ion-exchange resin powder.

Ion-exchange resin powder containing both cation-exchange resin powder and anion-exchange resin powder is preferable because of the capability of removing both basic gases (ammonia, amines, etc.) and acidic gases (SO_{X}, NO_{X}, etc.).

When the ion-exchange resin powder contains both cation-exchange resin powder and anion-exchange resin powder, their mixing ratio by weight is 2:8 to 8:2, and preferably 4:6 to 6:4. If the mixing ratio is outside of this range, the reactivity of either the cation-exchange resin powder or anion-exchange resin powder with ionized gaseous pollutants tends to decrease.

There are no specific limitations to the adhesive used in the present invention. Inorganic adhesives and organic adhesives can be given as examples. An adhesive containing either an inorganic adhesive or an organic adhesive is sufficient for use in the present invention. As the inorganic adhesive, silica sol, alumina sol, titania sol, sodium silicate, potassium silicate, and the like can be given. As the organic adhesive, acrylic resin, vinyl-acetate resin, epoxy resin, phenol resin, silicone resin, their copolymer resins, and the like can be given. Of these, inorganic adhesives are preferable because the cured products of the inorganic adhesives do not produce films but produce flocculants which provide spaces through which ionized gaseous pollutants can easily permeate and be removed at a high rate.

The slurry mixture used in the present invention can be obtained by mixing the ion-exchange resin powder, the adhesive, and water. A surfactant such as a dispersant can be optionally added. When an adhesive containing water is used, the water in the adhesive may be used as the water for the slurry mixture, although water may be separately added to the slurry mixture. For example, when the adhesive is silica sol, water other than that in the silica sol can be used as the water forming the slurry mixture. When the adhesive is an inorganic adhesive, the ratio by weight of the ion-exchange resin powder and the inorganic adhesive is 90:10 to 50:50, and preferably 85:15 to 75:25. When the adhesive is an organic adhesive, the ratio by weight of the ion-exchange resin powder and the organic adhesive is 99:1 to 80:20, and preferably 95:5 to 85:15. The concentration of the slurry mixture, specifically, the ratio of the total weight of solid components in the ion-exchange resin powder and adhesive to the total weight of the slurry mixture is usually 30-70 wt %, and preferably 40-60 wt %. The mixing ratio and the concentration of the slurry mixture in the above ranges can ensure sufficient attachment of the ion-exchange resin powder in the slurry mixture to the surface and the inside of the fiber paper by coating the fiber paper with the slurry mixture.

As examples of the method for coating the fiber paper with the slurry mixture, a method of applying the slurry mixture using a roll coater and a method of dipping the fiber paper into the slurry mixture can be given. Of these methods, the former method is preferable, because it is easy to continuously attach the ion-exchange resin powder to the surface and the inside of the fiber paper. As a specific example of implementing the former method, a method of using a coating apparatus 20 shown in FIGS. 1 and 2 can be given. A slurry mixture 11 is applied onto a flat fiber paper 2 conveyed on a conveyor belt 21 using a roll coater 22. A paper (an ion-exchange resin-coated paper) with the ion-exchange resin powder attached to the inside and surface of a fiber paper can be obtained by coating the fiber paper with a slurry mixture to in this manner.

If necessary, the coating treatment may be carried out two or more times. For example, when the ion-exchange resin powder in a slurry mixture is attached to only one of the surfaces and the inside of a fiber paper by coating the slurry mixture to one of the surfaces of the fiber paper due to a high slurry concentration or the like, the slurry mixture may be further coated onto the other side onto which the ion-exchange resin powder has not been attached. The coating apparatuses 20 shown in FIGS. 1 and 2 can be given as a specific example. FIGS. 1 and 2 show schematic drawings describing the process for manufacturing the paper coated with the ion-exchange resin powder of the present invention, wherein FIG. 1 shows a coating apparatus 20 viewed from one side and FIG. 2 shows a coating apparatus 20 viewed from the other side, that is, the opposite side of the FIG. 1.

In the coating operation using the coating apparatus 20 shown in FIG. 1, as a flat fiber paper 2 on a conveyor belt 21 is continuously forwarded in the direction of an arrow A, a slurry mixture 11 is applied onto the upper surface (a first coating surface 31) of the flat fiber paper 2 and dried to obtain a paper with an ion-exchange resin powder coated on one side 3a, which has the ion-exchange resin powder attached to the inside and the upper surface (the first coating surface 31) of the flat fiber paper 2. Next, as shown in FIG. 2, the paper with an ion-exchange resin powder coated onto the one side 3a is set on the coating apparatus 20 in the direction upside down the direction shown in FIG. 1, so that the coated surface (the first coating surface 31) faces downward and the uncoated surface (a second coating surface 32) faces upward. Next, as the paper with an ion-exchange resin powder coated on one side 3a is continuously forwarded in the direction of an arrow B, the slurry mixture 11 is applied onto the uncoated surface (the second coating surface 32) and dried in the same manner as in FIG. 1 to obtain a paper with the ion-exchange resin powder coated on both sides 3b, which has the ion-exchange resin powder attached to the inside and the both side surfaces (the first coating surface 31 and the second coating surface 32) of the flat fiber paper 2. An ion-exchange resin-coated paper with the ion-exchange resin powder attached to the inside and the both side surfaces of a fiber paper can be obtained by applying a slurry mixture to the both sides of a fiber paper in this manner.

The fiber paper 2 or the like coated with the slurry mixture is dried as required. A drying treatment is preferably implemented to ensure rapid attachment of the ion exchange resin powder to the surfaces and the inside of the fiber paper by the adhesive in the slurry mixture. As an example of the drying method, a method of heating the fiber paper or blowing a hot air to the fiber paper from a dryer 23 to the direction shown by an arrow X in FIGS. 1 and 2 can be given. Although there are no specific limitations, the drying treatment is carried out usually at a temperature of 50-130° C. for 5-30 minutes. When the coating treatment is carried out two or more times, it is desirable to dry the product each time the fiber paper is coated, because an increased amount of the ion-exchange resin powder can be attached in a subsequent coating treatment implemented after firm attachment of the ion-exchange resin powder by a drying treatment.

In the present invention, the chemical filter with a corrugated honeycomb structure is formed using the above-described paper coated with ion-exchange resin powder. To form the chemical filter with a corrugated honeycomb structure from the paper coated with ion-exchange resin powder, a flat paper coated with ion-exchange resin powder is first prepared. Next, the flat paper coated with ion-exchange resin powder is divided into a portion to be corrugated and a portion not to be corrugated. The corrugated paper is hereinafter referred to as a corrugated paper coated with ion-exchange resin powder. Corrugating is a process for fabricating a flat material such as a flat paper coated with ion-exchange resin powder into a waveform object by passing the flat paper through a pair of upper and lower corrugated rolls. Next, a chemical filter with a corrugated honeycomb structure is prepared by alternately laminating the flat paper coated with ion-exchange resin powder and the corrugated paper coated with ion-exchange resin powder using the corrugated paper as a center core.

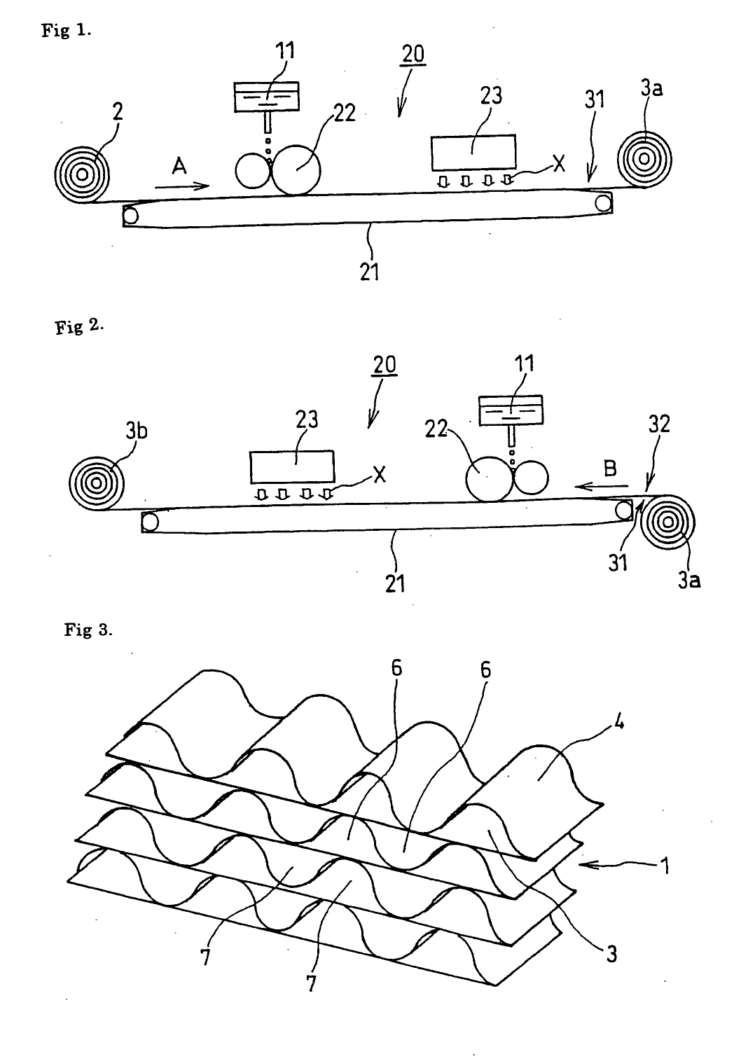

The chemical filter with a corrugated honeycomb structure will be explained using FIG. 3. FIG. 3 is a schematic perspective view of the chemical filter with a corrugated honeycomb structure obtained by the present invention. The chemical filter 1 with a corrugated honeycomb structure can be formed by integrating the corrugated paper coated with ion-exchange resin powder 4 (the center core) and the flat paper coated with ion-exchange resin powder 3 by causing upper mountains 5 and lower mountains 5 on the corrugated paper 4 to adhere to the flat paper 3 using an adhesive, or by securing a laminated body of the flat papers 3 and the corrugated papers 4 in a frame without adherence. When an adhesive is used for lamination, the same type of inorganic adhesives as those mentioned above such as silica sol can be used.

The chemical filter 1 prepared in this manner has a nearly half-cylindrical cave 6 extending in the direction of the continuous mountain 5 of the corrugated paper 4 coated with ion-exchange resin powder formed between the flat paper 3 coated with ion-exchange resin powder and the corrugated fiber paper 4. Therefore, the processed air introduced from an opening 7 can be passed through the cave 6.

FIG. 4 is a schematic cross-sectional view of the chemical filter 1 with a corrugated honeycomb structure along the plane parallel to the opening 7. The height of the mountains (h in FIG. 4) of the chemical filter 1 having a corrugated honeycomb structure is usually 0.5-10 mm, preferably 1-5 mm, and particularly preferably 1-2 mm. The pitch of the mountains (p in FIG. 4) of the chemical filter 1 having a corrugated honeycomb structure is usually 1-20 mm, preferably 1-5 mm, and particularly preferably 2-4 mm. The mountain height and the pitch length in the above ranges are preferable to maintain a good balance between ionic gaseous pollutant removal efficiency and pressure loss.

Because the ion-exchange resin is attached to the chemical filter of the present invention in the form of a powder, the chemical filter has a large ion exchange capacity per unit volume, a long life, and a small pressure loss with a small amount of ion-exchange resin attached thereto as compared with the case in which ion-exchange resin fiber is used. The ion exchange capacity per unit volume can be 750 eq/m³ or more, for example.

The chemical filter of the present invention can be used as a chemical filter for cleaning air in clean rooms and apparatuses in which ionized gaseous pollutants are produced in plants and the like for manufacturing semiconductors, liquid crystals, and precision electronic parts, particularly in a chemical filter for reducing the concentration of ionized gaseous pollutants to 10 ppb or less.

### EXAMPLES

The present invention will now be described in detail by way of examples and comparative examples, which are given as embodiments and are not intended to limit the present invention.

### Example 1

(Preparation of Slurry Mixture)

A slurry mixture 11 with a solid content (slurry concentration) of 40 wt % was prepared by mixing strongly acidic cation-exchange resin powder with an average particle diameter of 20 μm and an ion-exchange capacity of 5.0 meq/g (DIAION manufactured by Mitsubishi Chemical Corp.) and silica sol to be used as an adhesive in a proportion to make the ratio of the solid components of the cation-exchange resin powder and silica sol 8:2.

(Preparation of Chemical Filter with Corrugated Honeycomb Structure)

Using a roll coater 22, the slurry mixture 11 was applied onto the upper surface of a flat fiber paper 2 of silica alumina fiber (average fiber diameter: 5 μm, average fiber length: 20 mm) with an inter fiber void ratio of 90% and a thickness (t in FIG. 4) of 0.2 mm. After drying in a dryer 23 at 80° C., a flat paper 3a with ion-exchange resin powder attached to the inside and the upper side of the flat fiber paper 2 was rolled up (FIG. 1). Next, the flat paper 3a coated with the ion-exchange resin powder on one side was set with the coated surface downside to apply the slurry mixture 11 to the uncoated upper surface in the same manner as above, followed by drying. Then, a flat paper 3b with the ion-exchange resin powder attached to the inside and the upper and lower sides of the flat fiber paper was rolled up (FIG. 2).

A part of the flat paper 3b with the ion-exchange resin powder attached to the both sides was passed through a pair of upper and lower corrugated rolls to prepare a waveform paper 4b coated with the ion-exchange resin powder on both sides, which is to be used as a center core. After applying silica sol to the mountain parts of the center core 4b as an adhesive, the above flat fiber paper 3b coated with the ion-exchange resin powder on both sides was superposed and laminated. The center core and the flat fiber paper 3b coated with the ion-exchange resin powder on both sides were laminated in turn in the manner such that the air passages of the center cores are aligned in the same direction, thereby obtaining a chemical filter with a corrugated honeycomb structure shown in FIG. 3 and FIG. 4 with a center core pitch (p in FIG. 4) of 2.8 mm and a mountain height (h in FIG. 4) of 1.3 mm.

(Preparation of Chemical Filter)

The chemical filter with a corrugated honeycomb structure thus obtained was cut to a size of 100 mm (length)×100 mm (width)×70 mm (thickness) and inserted into an aluminum frame as an ion-exchange chemical filter.

The ion exchange capacity per unit volume of the chemical filter was 750 eq/m³ and the amount of the ion-exchange resin powder attached per unit volume of the chemical filter was 150 kg/m³. The ion exchange capacity per unit volume was determined by multiplying the weight of the attached ion-exchange resin powder by the ion exchange capacity of the ion-exchange resin powder.

(Measurement of Properties)

The change in the ammonia removal rate over time and the life of the chemical filter were determined under the following conditions. Although the ammonia concentration causing problems in a clean room in practice is in the order of ppb by weight (several parts by weight per one billion parts by weight), the ammonia concentration of 200 ppb by weight was used in the accelerated test. The results are shown in FIG. 5. The life of the chemical filter was 1400 hours. The period of time elapsed up to the time when the ammonia removal rate was decreased to as low as 90% was regarded as the life of the chemical filter. The pressure loss of the chemical filter determined under these conditions was 35 Pa. The results are shown in Table 1.

Test Conditions
Composition of feed gas: air containing 200 wt ppb of ammonia
Temperature and humidity of the feed gas: 23° C., 50% RH
Target gas to be removed: ammonia
Gas feed rate: 0.5 m/sec
Thickness of chemical filter: 70 mm

### Example 2

A chemical filter was prepared in the same manner as in Example 1, except that the concentration of solid components in the slurry mixture was 50 wt %, the ion exchange capacity per unit volume of the chemical filter was 1000 eq/m³, and the amount of the ion-exchange resin powder attached per unit volume of the chemical filter was 200 kg/m³.

The change in the ammonia removal rate over time and the life of the chemical filter were determined under the same conditions as used in Example 1. The results are shown in FIG. 5. The life of the chemical filter was 1600 hours. The pressure loss of the chemical filter determined in the same manner as in Example 1 was 35 Pa. The results are shown in Table 1.

### Comparative Example 1

A commercially available chemical filter (pitch: 3.3 mm, mountain height: 1.1 mm) with a size of 100 mm (length)×100 mm (width)×70 mm (thickness), prepared from a flat fiber paper similar to a filter paper, which was prepared from a multiple center island-type ion-exchange fiber containing cation-exchange groups (ion-exchange capacity: 3.5 meq/g) and heat-sealed fiber by paper milling, by obtaining a waveform fiber paper by corrugating the flat fiber paper and laminating the waveform fiber paper thus obtained with the flat fiber paper by alternately superposing them, was used. The ion exchange capacity per unit volume of the chemical filter was 700 eq/m³ and the amount of the ion-exchange resin fiber per unit volume of the chemical filter was 200 kg/m³.

The change in the ammonia removal rate over time and the life of the chemical filter were determined under the same conditions as used in Example 1. The results are shown in FIG. 5. The life of the chemical filter was 1200 hours. The pressure loss of the chemical filter determined in the same manner as in Example 1 was 40 Pa. The results are shown in Table 1.

### Comparative Example 2

A commercially available chemical filter (length: 100 mm, width: 100 mm, thickness: 70 mm) prepared from a non-woven fabric made from an organic polymer by irradiating the polymer with ionizing radiation followed by grafting cation-exchange groups (sulfonic acid groups) by folding the non-woven fabric in the form of a pleat was used. The ion exchange capacity per unit volume of the chemical filter was 175 eq/m³ and the amount of the ion-exchange resin fiber per unit volume of the chemical filter was 60 kg/m³.

The change in the ammonia removal rate over time and the life of the chemical filter were determined under the same conditions as used in Example 1. The results are shown in FIG. 5. The life of the chemical filter was 600 hours. The pressure loss of the chemical filter determined in the same manner as in Example 1 was 59 Pa. The results are shown in Table 1.

### Comparative Example 3

A commercially available honeycomb chemical filter (length: 100 mm, width: 100 mm, thickness: 70 mm) prepared from activated carbon fiber to which phosphoric acid was attached was used.

The change in the ammonia removal rate over time and the life of the chemical filter were determined under the same conditions as used in Example 1. The results are shown in FIG. 5. The life of the chemical filter was 193 hours. The pressure loss of the chemical filter determined in the same manner as in Example 1 was 40 Pa. The results are shown in Table 1.

TABLE 1

| | Example | | Comparative Example | | |
|---|---|---|---|---|---|
| | 1 | 2 | 1 | 2 | 3 |
| Ion exchange capacity per | 750 | 1000 | 700 | 175 | —*1 |
| unit volume (eq/m³) | | | | | |
| Ion exchange resin per | 150 | 200 | 200 | 60 | —*1 |
| unit volume (kg/m³) | | | | | |
| Life of chemical filter | 1400 | 1600 | 1200 | 600 | 193 |
| (hr) | | | | | |
| Pressure loss (Pa) | 35 | 35 | 40 | 59 | 40 |

—*1: Not measured because the chemical filter did not contain an ion exchange resin.

1. A method for manufacturing a chemical filter with a corrugated honeycomb structure comprising coating a fiber paper with a slurry mixture of an ion-exchange resin powder and an adhesive to obtain an ion-exchange resin-coated paper with the ion-exchange resin powder attached to the surface and inside of the fiber paper, and forming a chemical filter with a corrugated honeycomb structure using the ion-exchange resin-coated paper.

2. A method for manufacturing a chemical filter according to claim 1, wherein the slurry mixture is applied to both sides of the fiber paper and the ion-exchange resin-coated paper has the ion-exchange resin powder attached to the inside and both sides of the fiber paper.

3. The method for manufacturing the chemical filter according to claim 1 or claim 2, wherein the average particle diameter of the ion-exchange resin powder is 1-150 μm.

4. The method for manufacturing the chemical filter according to any one of claims 1-3, wherein the ion-exchange capacity of the ion-exchange resin powder is 1-10 meq/g.

5. The method for manufacturing the chemical filter according to any one of claims 1-4, wherein the ion-exchange resin powder comprises anion-exchange resin powder and cation-exchange resin powder.

6. The method for manufacturing the chemical filter according to any one of claims 1-5, wherein the adhesive comprises at least one of inorganic adhesives or organic adhesives.
